(19) United States
(12) Patent Application Publication
(10) Pub. No.: US 2026/0159721 A1
(43) Pub. Date: Jun. 11, 2026

(54) COATING KIT

(71) Applicant: SHINY CHEMICAL INDUSTRIAL CO., LTD., Kaohsiung City (TW)

(72) Inventors: Sheng-Wei LIN, Kaohsiung City (TW); Hsuan-Shen CHAO, Kaohsiung City (TW); Chi-Fa SUN, Kaohsiung City (TW)

(73) Assignee: SHINY CHEMICAL INDUSTRIAL CO., LTD., Kaohsiung City (TW)

(21) Appl. No.: 19/004,854

(22) Filed: Dec. 30, 2024

(30) Foreign Application Priority Data
Dec. 5, 2024 (TW) 113147301

(51) Int. Cl. C09D 183/04; C08K 3/36; C09D 5/08; C09D 7/61

(52) U.S. Cl. CPC C09D 183/04; C08K 3/36; C09D 5/084; C09D 7/61

(57) ABSTRACT

A coating kit includes an acidic agent and an alkaline agent. The acidic agent includes an alkoxysilane component present in an amount ranging from 25 wt % to 40 wt % based on 100 wt % of the acidic agent, and a first solvent. The alkoxysilane component includes a dialkoxy-substituted silane. The first solvent includes water and a first alcohol. The alkaline agent includes, based on 100 wt % of the alkaline agent, water, an aminoalkyl-substituted and alkoxy-substituted silane present in an amount ranging from 20 wt % to 50 wt %, and a second solvent. The second solvent includes a second alcohol. The acidic agent and the alkaline agent are separately packaged, and a weight ratio of the acidic agent to the alkaline agent ranges from 0.4 to 2.0 in decimal form. The alkoxysilane component is free from an aminoalkyl-substituted and alkoxy-substituted silane.

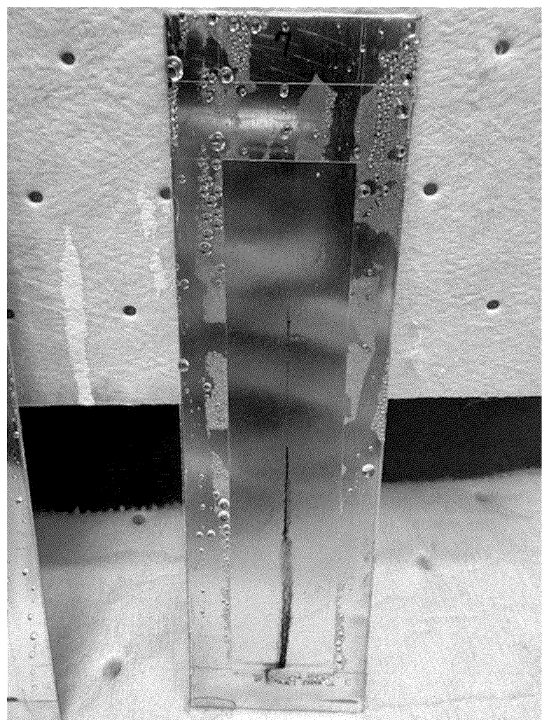

### CROSS-REFERENCE TO RELATED APPLICATION

This application claims priority to Taiwanese Invention Patent Application No. 113147301, filed on Dec. 5, 2024, the entire disclosure of which is incorporated by reference herein.

### FIELD

The disclosure relates to a coating material, and more particularly to a coating kit.

### BACKGROUND

Development of green electricity is a key energy policy project in many countries, and wind power generation is one of many approaches for producing green electricity. Most of wind turbines used for generating wind power are installed offshore, and hence suffers from long-term exposure to see breezes with high humidity and high salt content. If the wind turbines are not protected against corrosion, the service life thereof will be reduced.

One of the conventionally used anti-corrosion techniques is to coat the wind turbines with a coating material, such as a polyalkoxysilane (commonly known as polysiloxane), so that the wind turbines are able to resist corrosion. However, a disadvantage of a polyalkoxysilane-based anti-corrosion coating currently in use is that, after being coated to form a coating layer, the polyalkoxysilane-based anti-corrosion coating takes a long time, usually about 12 hours to 24 hours, to dry so as to form a protective film. Since the weather at sea is always changing, a longer time period for drying and film formation means lesser possibility for the aforesaid coating to be successfully implemented.

As a result, those skilled in the art strive to develop a new coating product that is capable of solving the aforesaid problems.

### SUMMARY

Therefore, an object of the disclosure is to provide a coating kit that can alleviate at least one of the drawbacks of the prior art. The coating kit includes:
an acidic agent which includes an alkoxysilane component present in an amount ranging from 25 wt % to 40 wt % based on 100 wt % of the acidic agent, and a first solvent, the alkoxysilane component including a dialkoxy-substituted silane present in an amount not less than 10 wt % based on 100 wt % of the alkoxysilane component, the first solvent including water and a first alcohol, and
an alkaline agent which includes, based on 100 wt % of the alkaline agent, water present in an amount not greater than 5 wt %, an aminoalkyl-substituted and alkoxy-substituted silane present in an amount ranging from 20 wt % to 50 wt %, and a second solvent, the second solvent including a second alcohol.

The acidic agent and the alkaline agent are separately packaged, and a weight ratio of the acidic agent to the alkaline agent ranges from 0.4 to 2.0 in decimal form. The alkoxysilane component is free from an aminoalkyl-substituted and alkoxy-substituted silane.

### BRIEF DESCRIPTION OF THE DRAWINGS

Other features and advantages of the disclosure will become apparent in the following detailed description of the embodiment(s) with reference to the accompanying drawings. It is noted that various features may not be drawn to scale.

The sole FIGURE is a photograph illustrating a result of a salt spray test for a test sample of Example 1.

### DETAILED DESCRIPTION

It is to be understood that, if any prior art publication is referred to herein, such reference does not constitute an admission that the publication forms a part of the common general knowledge in the art, in Taiwan or any other country.

For the purpose of this specification, it will be clearly understood that the word “comprising” means “including but not limited to”, and that the word “comprises” has a corresponding meaning.

Unless otherwise defined, all technical and scientific terms used herein have the meaning commonly understood by a person skilled in the art to which the present disclosure belongs. One skilled in the art will recognize many methods and materials similar or equivalent to those described herein, which could be used in the practice of the present disclosure. Indeed, the present disclosure is in no way limited to the methods and materials described.

The present disclosure provides a coating kit that includes:
an acidic agent which includes an alkoxysilane component present in an amount ranging from 25 wt % to 40 wt % based on 100 wt % of the acidic agent, and a first solvent, the alkoxysilane component including a dialkoxy-substituted silane present in an amount not less than 10 wt % based on 100 wt % of the alkoxysilane component, the first solvent including water and a first alcohol, and
an alkaline agent which includes, based on 100 wt % of the alkaline agent, water present in an amount not greater than 5 wt %, an aminoalkyl-substituted and alkoxy-substituted silane present in an amount ranging from 20 wt % to 50 wt %, and a second solvent, the second solvent including a second alcohol.

The acidic agent and the alkaline agent are separately packaged, and a weight ratio of the acidic agent to the alkaline agent ranges from 0.4 to 2.0 in decimal form. The alkoxysilane component is free from an aminoalkyl-substituted and alkoxy-substituted silane.

After the acidic agent and the alkaline agent are mixed to form a coating material, the coating material can be applied on a coating object to form a coating layer. Compared with a conventional coating layer formed from a conventional coating material, the coating layer of the present disclosure can be dried in a shorter time period so as to form a protective film that has an anti-corrosion effect.

### <Acidic Agent>

According to the present disclosure, the acidic agent includes the alkoxysilane component and the first solvent for hydrolysis of the alkoxysilane component. In certain embodiments, the acidic agent may further include a pH adjuster, which allows the acidic agent to have an acidic property, and an oxide, which allows the protective film formed from the coating kit of the present disclosure to be more wear-resistant or scratch-resistant.

According to the present disclosure, the acidic agent has a pH value of less than 7. In some embodiments, the pH value of the acidic agent may be less than 4, such as 1.0, 1.5, 2.0, 2.5, 2.8, 3.0, 3.2, or 3.5. In an exemplary embodiment, the pH value of the acidic agent is 3.0.

### <Alkoxysilane Component>

According to the present disclosure, the alkoxysilane component is an essential constituent that allows the protective film to be formed after application of the coating kit of the present disclosure, and is composed of monomers that can be polymerized into a polyalkoxysilane. In certain embodiments, based on 100 wt % of the acidic agent, the alkoxysilane component may be present in an amount of 26 wt %, 27 wt %, 28 wt %, 29 wt %, 30 wt %, 31 wt %, 32 wt %, 33 wt %, 34 wt %, 35 wt %, 36 wt %, 37 wt %, 38 wt %, or 39 wt %. If the alkoxysilane component is present in an amount of less than 25 wt % based on 100 wt % of the acidic agent, the protective film will not be formed after the acidic agent and the alkaline agent are mixed and coated into a coating layer. If the alkoxysilane component is present in an amount of greater than 40 wt % based on 100 wt % of the acidic agent, the amount of the first solvent will be relatively less, causing insufficient hydrolysis of the alkoxysilane component.

In certain embodiments, the alkoxysilane component may further include a trialkoxy-substituted silane and a tetraalkoxysilane. The properties of the protective film can be adjusted by using different silanes with different numbers of alkoxy substituent(s). In addition, since the monomers in the alkoxysilane component are expected to have a chain extension effect or a chain cross-linking effect, i.e., the monomers need to be polymerizable, the alkoxysilane component may mainly include the dialkoxy-substituted silane, the trialkoxy-substituted silane, and the tetraalkoxysilane. That is to say, the alkoxysilane component is free from a monoalkoxy-substituted silane.

According to the present disclosure, the dialkoxy-substituted silane can be used to improve the resilience and ductility of the protective film, the trialkoxy-substituted silane can be used to enhance the penetration resistance thereof, and the tetraalkoxysilane can be used to increase the structural density thereof.

In certain embodiments, in order to take into account all the aforesaid properties together, e.g., the resilience, the ductility, the penetration resistance, and the structural density, as well as bonding strength (adhesion), based on 100 wt % of the alkoxysilane component, the dialkoxy-substituted silane may be present in an amount ranging from 10 wt % to 35 wt %, the trialkoxy-substituted silane may be present in an amount ranging from 40 wt % to 80 wt %, and the tetraalkoxysilane may be present in an amount ranging from 10 wt % to 30 wt %.

### <Dialkoxy-Substituted Silane>

In certain embodiments, based on 100 wt % of the alkoxysilane component, the dialkoxy-substituted silane may be present in an amount of 11 wt %, 12 wt %, 13 wt %, 14 wt %, 15 wt %, 16 wt %, 17 wt %, 18 wt %, 19 wt %, 20 wt %, 21 wt %, 22 wt %, 23 wt %, 24 wt %, 25 wt %, 26 wt %, 27 wt %, 28 wt %, 29 wt %, 30 wt %, 31 wt %, 32 wt %, 33 wt %, or 34 wt %. An example of the dialkoxy-substituted silane may be a dialkoxydialkylsilane, such as a dimethoxydialkylsilane or a diethoxydialkylsilane. In still some embodiments, the dialkoxydialkylsilane may be the dimethoxydialkylsilane. In other embodiments, the dialkoxy-substituted silane may be a dimethoxy-substituted silane. In an exemplary embodiment, the dimethoxy-substituted silane is dimethoxydimethylsilane (CAS No. 1112-39-6). When the dialkoxy-substituted silane is present in an amount of less than 10 wt % based on 100 wt % of the alkoxysilane component, the protective film is not able to achieve satisfactory ratings in both adhesion and solvent resistance tests.

### <Trialkoxy-Substituted Silane>

In certain embodiments, based on 100 wt % of the alkoxysilane component, the trialkoxy-substituted silane may be present in an amount of 45 wt %, 50 wt %, 55 wt %, 60 wt %, 65 wt %, 70 wt %, or 75 wt %. In certain embodiments, based on 100 wt % of the alkoxysilane component, the trialkoxy-substituted silane may be present in an amount of not greater than 60 wt %, and when the trialkoxy-substituted silane is present in such amount, the protective film may achieve a relatively good rating in an adhesion test. In certain embodiments, based on 100 wt % of the alkoxysilane component, the trialkoxy-substituted silane may be present in an amount ranging from 40 wt % to 60 wt %.

In other embodiments, the trialkoxy-substituted silane may be a trimethoxy-substituted silane or a triethoxy-substituted silane. In an exemplary embodiment, the trialkoxy-substituted silane is the trimethoxy-substituted silane. In some embodiments, the trialkoxy-substituted silane may be a trimethoxy-substituted silane. In still some embodiments, the trimethoxy-substituted silane may be selected from the group consisting of methyltrimethoxysilane (CAS No. 1185-55-3), 3-glycidoxypropyltrimethoxysilane (CAS No. 2530-83-8), and a combination thereof. In an exemplary embodiment, the trimethoxy-substituted silane is the combination of the methyltrimethoxysilane and the 3-glycidoxypropyltrimethoxysilane. In other e alkoxysilane component may include the trialkoxy-substituted silane, which is the trimethoxy-substituted silane that is the combination of the methyltrimethoxysilane and the 3-glycidoxypropyltrimethoxysilane, and based on 100 wt % of the alkoxysilane component, the methyltrimethoxysilane may be present in an amount ranging from 10 wt % to 25 wt %, and a total amount of the methyltrimethoxysilane and the 3-glycidoxypropyltrimethoxysilane may range from 40 wt % to 80 wt %. In certain embodiments, the methyltrimethoxysilane may be present in an amount of 11 wt %, 12 wt %, 13 wt %, 14 wt %, 15 wt %, 16 wt %, 17 wt %, 18 wt %, 19 wt %, 20 wt %, 21 wt %, 22 wt %, 23 wt %, or 24 wt % based on 100 wt % of the alkoxysilane component.

### <Tetraalkoxysilane>

In certain embodiments, based on 100 wt % of the alkoxysilane component, the tetraalkoxysilane may be present in an amount of 11 wt %, 12 wt %, 13 wt %, 14 wt %, 15 wt %, 16 wt %, 17 wt %, 18 wt %, 19 wt %, 20 wt %, 21 wt %, 22 wt %, 23 wt %, 24 wt %, 25 wt %, 26 wt %, 27 wt %, 28 wt %, or 29 wt %. In an exemplary embodiment, the tetraalkoxysilane is tetraethoxysilane (CAS No. 78-10-4; also known as tetraethyl orthosilicate (TEOS)). In some embodiments, the tetraalkoxysilane may be omitted by increasing a proportion (amount) of the trialkoxy-substituted silane in the alkoxysilane component. In still some embodiments, the alkoxysilane component may include the trialkoxy-substituted silane and may be free from a tetraalkoxysilane, and the dialkoxy-substituted silane may be present in an amount ranging from 10 wt % to 35 wt % based on 100 wt % of the alkoxysilane component.

Due to alkoxy groups with different chain lengths (i.e., different carbon numbers) having different hydrolysis rates, and in order to appropriately control the degree of hydrolysis thereof, the tetraalkoxysilane can be selected from an ethoxysilane (i.e., the tetraethoxysilane), while the dialkoxy-substituted silane and the trialkoxy-substituted silane can each be selected from a methoxysilane (i.e., the dimethoxydimethylsilane, and the methyltrimethoxysilane and/or the 3-glycidoxypropyltrimethoxysilane, respectively), so that the alkoxysilane component can form a desired spatial structure, thereby enhancing properties, such as drying time, adhesion, or solvent resistance, of the protective film.

### <pH Adjuster>

According to the present disclosure, the pH adjuster allows the acidic agent to have the acidic property, so as to promote hydrolysis of the alkoxysilane component. The pH adjuster may be a weak acid or a strong acid. Examples of the weak acid may include acetic acid and citric acid. Examples of the strong acid may include hydrochloric acid, hydrofluoric acid, and sulfuric acid. In some embodiments, the pH adjuster may be the strong acid, such as the hydrochloric acid. The amount and concentration of the pH adjuster are not particularly limited, and can be adjusted according to practical requirements so that the pH value of the acidic agent is within the above-mentioned range.

### <First Solvent>

According to the present disclosure, the first solvent includes water and a first alcohol, both of which work in conjunction with the pH adjuster to enhance the hydrolysis of the alkoxysilane component. In some embodiments, the first alcohol may be selected from the group consisting of isopropanol, ethanol, n-propanol, and butanol. In an exemplary embodiment, the first alcohol is isopropanol. In other embodiments, the first alcohol may be a hydrocarbon alcohol. According to the present disclosure, the first alcohol may contain some of the water, and at times, the some of the water in the first alcohol may be present in a very small amount, i.e., the first alcohol is nearly anhydrous. In some embodiments, the first alcohol may be an alcoholic solution with an alcoholic concentration of not less than 95 wt %. In certain embodiments, the alcoholic concentration of the alcoholic solution may be not less than 99.5 wt %. In other embodiments, the first alcohol may be present in an amount ranging from 20 wt % to 30 wt % based on 100 wt % of the acidic agent, such as 21 wt %, 22 wt %, 23 wt %, 24 wt %, 25 wt %, 26 wt %, 27 wt %, 28 wt %, or 29 wt %.

### <Oxide>

In certain embodiments, the oxide may be selected from the group consisting of silicon dioxide, titanium dioxide, zirconium dioxide, and combinations thereof. In an exemplary embodiment, the oxide is the silicon dioxide. In certain embodiments, the oxide may be present in an amount ranging from 5 wt % to 15 wt % based on 100 wt % of the acidic agent. For instance, the oxide may be present in an amount of 6 wt %, 7 wt %, 8 wt %, 9 wt %, 10 wt %, 11 wt %, 12 wt %, 13 wt %, or 14 wt %, based on 100 wt % of the acidic agent. When the acidic agent includes the oxide, the protective film may be more wear-resistance or scratch-resistant. In some embodiments, the oxide may be a nanoscale oxide, particularly referring to a dioxide with a particle size (particle diameter) ranging from 5 nm to 60 nm. In other embodiments, the particle size of the oxide may be 10 nm, 20 nm, 30 nm, 40 nm, or 50 nm.

In certain embodiments, the acidic agent may be prepared by subjecting the alkoxysilane component and the first agent (or the aforementioned ingredients, i.e., the alkoxysilane component, the first solvent, the pH adjuster, and the oxide) to a heat treatment at a temperature ranging from 60° C. to 80° C. for a time period ranging from 4 hours to 9 hours, so as to hydrolyze the alkoxysilane component (which may include the dialkoxy-substituted silane, the trialkoxy-substituted silane, and the tetraalkoxysilane). In some embodiments, the aforesaid ingredients in the acidic agent are mixed simultaneously or nearly simultaneously. That is to say, the alkoxysilane component, the first solvent, the pH adjuster, and the oxide may be mixed simultaneously.

### <Alkaline Agent>

According to the present disclosure, the alkaline agent has a pH value of greater than 7, such as 7.5, 8.0, 8.5, 9.0, or 9.5. In certain embodiments, the pH value of the alkaline agent may be not less than 10, such as 10.5, 11.0, 11.5, 12.0, 12.5, or 13.0.

### <Aminoalkyl-Substituted and Alkoxy-Substituted Silane>

Based on 100 wt % of the alkaline agent, the aminoalkyl-substituted and alkoxy-substituted silane may be present in an amount of 21 wt %, 22 wt %, 23 wt %, 24 wt %, 25 wt %, 26 wt %, 27 wt %, 28 wt %, 29 wt %, 30 wt %, 31 wt %, 32 wt %, 33 wt %, 34 wt %, 35 wt %, 36 wt %, 37 wt %, 38 wt %, 39 wt %, 40 wt %, 41 wt %, 42 wt %, 43 wt %, 44 wt %, 45 wt %, 46 wt %, 47 wt %, 48 wt %, or 49 wt %. In certain embodiments, the aminoalkyl-substituted and alkoxy-substituted silane may be 3-aminopropyltrimethoxysilane (CAS No. 13822-56-5) or N-2-(aminoethyl)-3-aminopropyltrimethoxysilane (CAS No. 1760-24-3). In an exemplary embodiment, the aminoalkyl-substituted and alkoxy-substituted silane is the 3-aminopropyltrimethoxysilane. By virtue of controlling the aminoalkyl-substituted and alkoxy-substituted silane to be present in an amount ranging from 20 wt % to 50 wt % based on 100 wt % of the alkaline agent, the alkaline agent is allowed to have an alkaline property as a whole, and the pH value of the acidic agent can be elevated after the acidic agent is mixed with the alkaline agent. Due to elevation of the pH value, the alkoxysilane component and the aminoalkyl-substituted and alkoxy-substituted silane are allowed to undergo a polymerization reaction to form a polyalkoxysilane, thereby forming the protective film. According to the present disclosure, the aminoalkyl-substituted and alkoxy-substituted silane is designed to be present in the alkaline agent rather than in the acidic agent. In other words, the alkoxysilane component in the acidic agent does not contain an aminoalkyl-substituted and alkoxy-substituted silane.

### <Second Solvent>

According to the present disclosure, the second solvent includes the second alcohol and has no additional water added thereto. Alternatively, the alkaline agent may include the water that is difficult to separate from the second alcohol. In certain embodiments, based on 100 wt % of the alkaline agent, an amount of the water is controlled to be not greater than 5 wt %, such as 0 wt %, or not greater than 1 wt %, not greater than 2 wt %, not greater than 3 wt %, or not greater than 4 wt %. As an example, when the second alcohol in the second solvent has an alcoholic concentration of not less than 95 wt % (with the water being a remainder), and the aminoalkyl-substituted and alkoxy-substituted silane is present in an amount of 20 wt % (i.e., a minimum amount thereof) based on 100 wt % of the alkaline agent, a maximum amount of the water can merely reach up to 4 wt % ((100 wt %-20 wt %)×0.05=4 wt %) based on 100 wt % of the alkaline agent. In some embodiments, the second alcohol may be selected from the group consisting of isopropanol, ethanol, n-propanol, and butanol. In an exemplary embodiment, the second alcohol is isopropanol.

### <Weight Ratio of the Acidic Agent to the Alkaline Agent>

According to the present disclosure, the weight ratio of the acidic agent to the alkaline agent ranges from 0.4 to 2.0 in decimal form, such as 0.5, 0.6, 0.7, 0.8, 0.9, 1.0, 1.1, 1.2, 1.3, 1.4, 1.5, 1.6, 1.7, 1.8, or 1.9. In some embodiments, when the alkoxysilane component includes the dialkoxy-substituted silane, the trialkoxy-substituted silane, and the tetraalkoxysilane, the weight ratio of the acidic agent to the alkaline agent may be not less than 0.6 in decimal form. In still some embodiments, the weight ratio of the acidic agent to the alkaline agent may range from 0.6 to 2.0 in decimal form. In yet some embodiments, the weight ratio of the acidic agent to the alkaline agent may range from 0.6 to 0.8 in decimal form. In other embodiments, when the alkoxysilane component only includes the dialkoxy-substituted silane and the trialkoxy-substituted silane, the weight ratio of the acidic agent to the alkaline agent may be reduced to 0.4 in decimal form.

Due to the effects exerted by the acidic agent and the alkaline agent, the drying time of the coating layer (i.e., time required to form the protective film), which is formed from the coating material obtained by mixing the acidic agent with the alkaline agent, can be effectively reduced. To be specific, under a drying temperature of approximately 50° C., the coating layer can be dried in approximately 3 hours to form the protective film, which allows the coating kit of the present disclosure to be successfully obtained so as to achieve an anti-corrosion effect. Additionally, the protective film thus formed is capable of meeting requirements in both adhesion and solvent resistance.

The present disclosure will be further described by way of the following examples. However, it should be understood that the following examples are intended solely for the purpose of illustration and should not be construed as limiting the present disclosure in practice.

### EXAMPLES

### <Details of Ingredients>

The sources, specifications, and other information of ingredients used in the following examples are shown in Table 1 below.

TABLE 1

| | | | Other |
|---|---|---|---|
| Ingredient | Source | Specification | information |
| Dimethoxydimethylsilane | Topco | >99% | MW²: 120.2 |
| | Technologies | (RG¹) | g/mol |
| | Corp. | | |
| Methyltrimethoxysilane | Topco | 100% | MW: 136.2 |
| | Technologies | (RG) | g/mol |
| | Corp. | | |
| 3-glycidoxypropyltri- | Topco | >99% | MW: 236.3 |
| methoxysilane | Technologies | (RG) | g/mol |
| | Corp. | | |
| Tetraethoxysilane | Thermo | 98% | MW: 208.33 |
| | Fisher | | g/mol |
| | Scientific | | |
| | Inc. | | |
| 3-aminopropyltri- | Topco | >99% | MW: 179.3 |
| methoxysilane | Technologies | (RG) | g/mol |
| | Corp. | | |
| Water | — | | Metal |
| | | | content: |
| | | | ppb³ level |
| Isopropanol | Sigma- | >99.5% | MW: 46.07 |
| | Aldrich | (RG) | g/mol |
| Hydrochloric acid | Honeywell | 37% | — |
| | | (RG) | |

RG: reagent grade
MW: molecular weight
ppb: parts per billion

### Example 1

The coating kit of Example 1 included an acidic agent and an alkaline agent, both of which are separately packaged.

Referring to Table 2, the acidic agent included, based on 100 wt % thereof, an alkoxysilane component present in an amount of 29 wt %, a first solvent present in an amount of 60 wt %, a pH adjuster present in an amount of 1 wt %, and an oxide present in an amount of 10 wt %. The acidic agent had a pH value approximately ranging from 3 to 4.

In addition, the alkoxysilane component included, based on 100 wt % thereof, dimethoxydimethylsilane (a dimethoxy-substituted silane serving as a dialkoxy-substituted silane) present in an amount of 24 wt %, methyltrimethoxysilane present in an amount of 12 wt %, 3-glycidoxypropyltrimethoxysilane (the former two are deemed as a trimethoxy-substituted silane serving as a trialkoxy-substituted silane) present in an amount of 42 wt %, and tetraethoxysilane (serving as a tetraalkoxysilane) present in an amount of 22 wt %. In other words, based on 100 wt % of the alkoxysilane component, the trialkoxy-substituted silane (alternatively, the trimethoxy-substituted silane) was present in an amount of 54 wt % (12 wt %+42 wt %=54 wt %).

Specifically, the first solvent included, based on 100 wt % thereof, water present in an amount of 36 wt %, and isopropanol (serving as a first alcohol) present in an amount of 24 wt %. The isopropanol had an isopropanol concentration of not less than 99.5 wt %. The pH adjuster was a 0.2 N hydrochloric acid. The oxide was particles of silicon dioxide having an average particle size ranging from 10 nm to 15 nm.

The aforesaid ingredients (i.e., the alkoxysilane component, the first solvent, the pH adjuster, and the oxide) of the acidic agent were mixed simultaneously, then subjected to a heat treatment at 80° C. for 8 hours, and subsequently left to stand for subsequent use.

In addition, the alkaline agent included, based on 100 wt % thereof, 3-aminopropyltrimethoxysilane (serving as an aminoalkyl-substituted and alkoxy-substituted silane) present in an amount of 31 wt %, and a second solvent present in an amount of 69 wt %. The second solvent was isopropanol (serving as a second alcohol), and had an isopropanol concentration of not less than 99.5 wt %. The alkaline agent had a pH value approximately ranging from 11 to 12.

### Examples 2 to 6

The procedures for preparing a coating kit of each of Examples 2 to 6 were similar to those of Example 1, except that the amounts (proportion (wt %)) of ingredients in each of the acidic agent and the alkaline agent were varied as shown in Tables 2 and 3 below. In addition, it should be noted that in Example 6, no tetraalkoxysilane (i.e., tetraethoxysilane) was used, but only a dialkoxy-substituted silane and a trialkoxy-substituted silane were included in the alkoxysilane component of the acidic agent.

### Comparative Example 1

The coating substance of Comparative Example 1 was prepared using technology well known to those skilled in the art. To be more specific, only the acidic agent was prepared to serve as the coating substance in this example, and ingredients as well as the amounts (proportions (wt %)) thereof in the acidic agent of Comparative Example 1 were shown in Table 4 below.

### Comparative Examples 2 to 5

The procedures for preparing a coating kit of each of Comparative Examples 2 to 5 were similar to those of in Example 1, except that, the amount of each of the 3-aminopropyltrimethoxysilane and the second solvent in the alkaline agent of each of Comparative Examples 2 and 3, and the amounts of ingredients in each of the acidic agent and the alkaline agent of Comparative Example 5, were varied as shown in Tables 4 and 5 below. Additionally, regarding Comparative Example 5, attention should be paid to the impact of a decreased amount of the dialkoxy-substituted silane.

### <Preparation of Test Samples>

First, the acidic agent and the alkaline agent obtained in each of Examples 1 to 6, and Comparative Examples 2 to 5 were mixed in a weight ratio (in decimal form) as shown in Tables 2 to 5, so as to obtain a coating material having a pH value approximately ranging from 6 to 7. As for Comparative Example 1, the acidic agent, i.e., the coating substance, was solely used as the coating material. Next, a suitable amount of the coating material in each example was coated on a tinplate having a size of approximately 17 cm×4 cm, so as to cover an entire surface of the tinplate, thereby forming a coating layer having a thickness of approximately 10 μm thereon. The coating layer was dried to form a protective film, so as to obtain a test sample of each of Examples 1 to 6, and Comparative Examples 1 to 5.

TABLE 2

| | | | Example | | |
|---|---|---|---|---|---|
| | | | 1 | 2 | 3 |
| Alkoxysilane | Dialkoxy- | Dimethoxydimethylsilane | 24 | 30 | 12.4 |
| component | substituted | (wt %) | | | |
| | silane | | | | |
| | Trialkoxy- | Methyltrimethoxysilane | 12 | 15 | 23 |
| | substituted | (wt %) | | | |
| | silane | 3- | 42 | 27 | 52.3 |
| | | glycidoxypropyltrimethoxysilane | | | |
| | | (wt %) | | | |
| | Total amount of trialkoxy-substituted silane | | 54 | 42 | 75.3 |
| | (wt %) | | | | |
| | Tetraalkoxy | Tetraethoxysilane (wt %) | 22 | 28 | 12.3 |
| | silane | | | | |
| Total amount of alkoxysilane component (wt %) | | | 100 | 100 | 100 |
| Acidic | Alkoxysilane component (wt %) | | 29 | 27 | 39 |
| agent | First | Water (wt %) | 36 | 38 | 31 |
| | solvent | Isopropanol (wt %) | 24 | 24 | 19 |
| | Total amount of first solvent (wt %) | | 60 | 62 | 50 |
| | pH adjuster | Hydrochloric acid | 1 | 1 | 1 |
| | Oxide | Silicon dioxide | 10 | 10 | 10 |
| Total amount of acidic agent | | | 100 | 100 | 100 |
| Alkaline | Aminoalkyl- | 3-aminopropyltrimethoxysilane | 31 | 25 | 31 |
| agent | substituted | | | | |
| | and alkoxy- | | | | |
| | substituted | | | | |
| | silane | | | | |
| | Second | Isopropanol | 69 | 75 | 69 |
| | solvent | | | | |

| | | | |
|---|---|---|---|
| Total amount of alkaline agent | 100 | 100 | 100 |
| Weight ratio of acidic agent to alkaline agent | 0.78 | 0.71 | 0.69 |
| (in decimal form) | | | |

TABLE 3

| | | | Example | | |
|---|---|---|---|---|---|
| | | | 4 | 5 | 6 |
| Alkoxysilane | Dialkoxy- | Dimethoxydimethylsilane | 10 | 24 | 34.5 |
| component | substituted | (wt %) | | | |
| | silane | | | | |
| | Trialkoxy- | Methyltrimethoxysilane | 12 | 12 | 19 |
| | substituted | (wt %) | | | |
| | silane | 3- | 50 | 42 | 46.5 |
| | | glycidoxypropyltrimethoxysilane | | | |
| | | (wt %) | | | |
| | Total amount of trialkoxy-substituted silane | | 62 | 54 | 65.5 |
| | (wt %) | | | | |
| | Tetraalkoxy | Tetraethoxysilane (wt %) | 28 | 22 | 0 |
| | silane | | | | |
| Total amount of alkoxysilane component (wt %) | | | 100 | 100 | 100 |
| Acidic | Alkoxysilane component (wt %) | | 27.5 | 27 | 33 |
| agent | First | Water (wt %) | 37 | 46 | 34 |
| | solvent | Isopropanol (wt %) | 25 | 26 | 23 |
| | Total amount of first solvent (wt %) | | 62 | 72 | 57 |
| | pH adjuster | Hydrochloric acid | 1 | 1 | 1 |
| | Oxide | Silicon dioxide | 9.5 | 0 | 9 |
| Total amount of acidic agent | | | 100 | 100 | 100 |
| Alkaline | Aminoalky- | 3-aminopropyltrimethoxysilane | 30 | 48 | 44 |
| agent | substituted | | | | |
| | and alkoxy- | | | | |
| | substituted | | | | |
| | silane | | | | |
| | Second | Isopropanol | 70 | 52 | 56 |
| | solvent | | | | |

| | | | |
|---|---|---|---|
| Total amount of alkaline agent | 100 | 100 | 100 |
| Weight ratio of acidic agent to alkaline agent | 0.75 | 1.7 | 0.43 |
| (in decimal form) | | | |

TABLE 4

| | | | Comparative Example | | |
|---|---|---|---|---|---|
| | | | 1 | 2 | 3 |
| Alkoxysilane | Dialkoxy- | Dimethoxydimethylsilane | 36 | 24 | 24 |
| component | substituted | (wt %) | | | |
| | silane | | | | |
| | Trialkoxy- | Methyltrimethoxysilane | 37 | 12 | 12 |
| | substituted | (wt %) | | | |
| | silane | 3- | 5 | 42 | 42 |
| | | glycidoxypropyltrimethoxysilane | | | |
| | | (wt %) | | | |
| | Total amount of trialkoxy-substituted silane | | 42 | 54 | 54 |
| | (wt %) | | | | |
| | Tetraalkoxy | Tetraethoxysilane (wt %) | 22 | 22 | 22 |
| | silane | | | | |
| Total amount of alkoxysilane component (wt %) | | | 100 | 100 | 100 |
| Acidic | Alkoxysilane component (wt %) | | 21.5 | 29 | 29 |
| agent | First | Water (wt %) | 44 | 36 | 36 |
| | solvent | Isopropanol (wt %) | 22.5 | 24 | 24 |
| | Total amount of first solvent (wt %) | | 66.5 | 60 | 60 |
| | pH adjuster | Hydrochloric acid | 1 | 1 | 1 |
| | Oxide | Silicon dioxide | 11 | 10 | 10 |
| Total amount of acidic agent | | | 100 | 100 | 100 |
| Alkaline | Aminoalkyl- | 3-aminopropyltrimethoxysilane | — | 32 | 32 |
| agent | substituted | | | | |
| | and alkoxy- | | | | |
| | substituted | | | | |
| | silane | | | | |
| | Second | Isopropanol | | 68 | 68 |
| | solvent | | | | |

| | | | |
|---|---|---|---|
| Total amount of alkaline agent | | 100 | 100 |
| Weight ratio of acidic agent to alkaline agent | — | 0.1 | 0.39 |
| (in decimal form) | | | |

TABLE 5

| | | | Comparative Example | |
|---|---|---|---|---|
| | | | 4 | 5 |
| Alkoxysilane | Dialkoxy- | Dimethoxydimethylsilane | 24 | 2.5 |
| component | substituted | (wt %) | | |
| | silane | | | |
| | Trialkoxy- | Methyltrimethoxysilane | 12 | 17.7 |
| | substituted | (wt %) | | |
| | silane | 3- | 42 | 50.7 |
| | | glycidoxypropyltrimethoxysilane | | |
| | | (wt %) | | |
| | Total amount of trialkoxy-substituted silane | | 54 | 68.5 |
| | (wt %) | | | |
| | Tetraalkoxy | Tetraethoxysilane (wt %) | 22 | 29 |
| | silane | | | |
| Total amount of alkoxysilane component (wt %) | | | 100 | 100 |
| Acidic | Alkoxysilane component (wt %) | | 29 | 29 |
| | First | Water (wt %) | 36 | 36.8 |
| | solvent | Isopropanol (wt %) | 24 | 24 |
| | Total amount of first solvent (wt %) | | 60 | 60.8 |
| | pH adjuster | Hydrochloric acid | 1 | 1 |
| | Oxide | Silicon dioxide | 10 | 9.2 |
| Total amount of acidic agent | | | 100 | 100 |
| Alkaline | Aminoalkyl- | 3-aminopropyltrimethoxysilane | 31 | 39 |
| agent | substituted | | | |
| | and alkoxy- | | | |
| | substituted | | | |
| | silane | | | |
| | Second | Isopropanol | 69 | 61 |
| | solvent | | | |

| | | |
|---|---|---|
| Total amount of alkaline agent | 100 | 100 |
| Weight ratio of acidic agent to alkaline agent | 3.2 | 0.44 |
| (in decimal form) | | |

### Property Evaluation

### <Salt Spray Test>

The test sample of Example 1 was subjected to a salt spray test using a conventional salt spray testing machine as follows. Briefly, a testing solution which included sodium chloride with a concentration of 50 g±5 g per liter of water and which had a pH value approximately ranging from 6.5 to 7.2 was prepared. Next, a cut (from which a result of the salt spray test can be observed) was made on the protective film of the test sample of Example 1, and then the testing solution was sprayed onto the test sample, followed by leaving the test sample with the testing solution thereon to stand in an environment having a temperature of 35° C.±2° C. and a relative humidity (RH) of greater than 95% for one week. After that, the resultant test sample was subjected to observation of penetration resistance of the protective film.

Referring to the FIGURE, an unprotected area of the resultant test sample, i.e., an area where the cut was made on the protective film, indeed showed signs of rusting. However, no rust appeared in other areas of the resultant test sample that were protected by the protective film. These results demonstrated that the protective film formed in Example 1 was capable of preventing penetration of salt and moisture, and hence could be used to withstand exposure to sea breeze.

### <Determination of Drying Time>

During preparation of the test sample, the coating material formed from the coating kit of each of Examples 1 to 6 and Comparative Examples 2 to 5 was further subjected to determination of drying time. First, calculation of timing started immediately after the coating material was coated on the tinplate to form the coating layer thereon. Next, under a drying temperature of 50° C., the coating layer was periodically touched with a finger until no visible fingerprint could be detected on the coating layer. At this point, the coating layer was considered dried enough to form the protective film, and hence calculation of the timing was stopped, thereby obtaining the drying time of each example. Since the ingredients used in Comparative Example 1 (specifically, the ingredients in the acidic agent) were well known to those skilled in the art, the time period required for forming the protective film by such acidic agent would be relatively long, that is, about 12 hours to 24 hours. As a result, in Comparative Example 1, determination of drying time was not performed.

The results were shown in Tables 6 and 7 below.

### <Determination of Adhesion>

The test sample of each of Examples 1 to 6 and Comparative Examples 1 to 5 was subjected to determination of adhesion in accordance with the American Society for Testing and Materials (ASTM) D3359 (Standard Test Methods for Rating Adhesion by Tape Test). First, the protective film of the test sample was subjected to a cutting treatment using a cross-cut tester in a criss-cross pattern, thereby forming multiple intersecting lines on the protective film and grid patterns, which were square pieces of the protective film defined by the multiple intersecting lines. Thereafter, the adhesion between the protective film (i.e., the grid patterns) and the tinplate was evaluated by observing the peeling degree of the protective film (i.e., the grid patterns) which was determined using the criteria shown in Table 6 below.

TABLE 6

| | Classification of | |
|---|---|---|
| Grade | ASTM D3359 | Peeling degree |
| Excellent | 5B | No peeling observed |
| Good | 4B | x¹ < (y² × 5%) |
| Poor | 3B | (y × 5%) ≤ x < (y × 15%) |
| Poor | 2B | (y × 15%) ≤ x < (y × 35%) |
| Poor | 1B | (y × 35%) ≤ x ≤ (y × 65%) |
| Poor | 0B | x > (y × 65%) |

¹x: peeling area of grid pattern(s) (protective film)
²y: total area of the grid patterns (protective film)

The results were shown in Tables 8 and 9 below.

### <Determination of Solvent Resistance>

The test sample of each of Examples 1 to 6 and Comparative Examples 1 to 5 was subjected to determination of solvent resistance in accordance with the ASTM D4752 (Standard Practice for Measuring MEK Resistance of Ethyl Silicate (Inorganic) Zinc-Rich Primers by Solvent Rub). First, a piece of coarse cotton cloth was folded, followed by saturating the piece of coarse cotton cloth with methyl ethyl ketone (MEK), thereby obtaining a fully saturated cloth. Subsequently, the fully saturated cloth was used to rub the protective film of the test sample back and forth for 50 times. Thereafter, the solvent resistance of the protective film was evaluated by observing surface changes thereof which was determined using the criteria shown in Table 7 below.

TABLE 7

| | Classification of | |
|---|---|---|
| Grade | ASTM D4752 | Rubbing result |
| Excellent | 5 | No effect on rubbed area¹ is |
| | | observed |
| Good | 4 | Rubbed area is polished |
| Acceptable | 3 | Rubbed area is slightly |
| | | damaged |
| Poor | 2 | Rubbed area is severely |
| | | damaged |
| Poor | 1 | Rubbed area is severely |
| | | damaged and depressed |
| Poor | 0 | Rubbed area is penetrated |

¹area of the protective film that was rubbed by the fully saturated cloth

The results were shown in Tables 8 to 9 below.

TABLE 8

| | | | Example | | | | | |
|---|---|---|---|---|---|---|---|---|
| | | | 1 | 2 | 3 | 4 | 5 | 6 |
| Property | Determination | Drying | 50 | 50 | 50 | 50 | 50 | 50 |
| evaluation | of drying time | temperature | | | | | | |
| | | (° C.) | | | | | | |
| | | Drying time | 3 | 3 | 3 | 3 | 3 | 3 |
| | | (hour(s)) | | | | | | |
| | Determination | Adhesion | Excellent | | Good | | | |
| | of adhesion | | | | | | | |
| | Determination | Solvent | Excellent | | | | Good | |
| | of solvent | resistance | | | | | | |
| | resistance | | | | | | | |

TABLE 9

| | | | Comparative Example | | | | |
|---|---|---|---|---|---|---|---|
| | | | 1 | 2 | 3 | 4 | 5 |
| Property | Determination of drying | Drying | — | 50 | 50 | 50 | 50 |
| evaluation | time | temperature (° C.) | | | | | |
| | | Drying time | — | 3 | 3 | 3 | 3 |
| | | (hour(s)) | | | | | |
| | Determination of adhesion | Adhesion | Poor | | | Excellent | Poor |
| | Determination of solvent | Solvent resistance | Poor | Acceptable | | Poor | |
| | resistance | | | | | | |

### Results

Referring to Tables 2, 3 and 8, it could be seen from each of Examples 1 to 6 that when the acidic agent included, based on 100 wt % thereof, the alkoxysilane component that was present in the amount ranging from 27 wt % to 39 wt %, the pH adjuster that was present in the amount of 1 wt %, and the first solvent that was present in the amount ranging from 50 wt % to 72 wt %, when the alkaline agent included, based on 100 wt % thereof, the aminoalkyl-substituted and alkoxy-substituted silane that was present in the amount ranging from 25 wt % to 48 wt %, and when the weight ratio of the acidic agent to the alkaline agent ranged from 0.43 to 1.7 in decimal form, film formation could be completed (the protective film could be formed) in approximately 3 hours under a drying temperature of 50° C. Compared to a coating substance of Comparative Example 1, which typically requires a drying time ranging from 12 hours to 24 hours, the coating kit of the present disclosure significantly reduces the time required for drying (the film formation), thereby allowing such coating kit to be successfully implemented to achieve an anti-corrosion effect. In addition, the protective film of each of Examples 1 to 6 formed from the coating kit of the present disclosure received a grade of “excellent” or “good” in either adhesion or solvent resistance, thereby having a commercial value. Due to lack of the alkaline agent in Comparative Example 1, the acidic agent of Comparative Example 1 not only would require a drying time of approximately 12 hours to 24 hours, but also received a grade of “poor” in each of adhesion and solvent resistance, making such acidic agent less commercially competitive.

Moreover, in each of Examples 3, 4, and 6, when the total amount of the trialkoxy-substituted silane was greater than 60 wt % (e.g., 75.3 wt % in Example 3, 62 wt % in Example 4, and 65.5 wt % in Example 6) based on 100 wt % of the alkoxysilane component, the protective film thus obtained became relatively hard and brittle. As a result, the protective film of each of Examples 3, 4, and 6 exhibited less ductility compared to that of Example 1 or 2, thus receiving merely a grade of “good” in adhesion. Conversely, in each of Examples 1 and 2, when the total amount of the trialkoxy-substituted silane was not greater than 60 wt % (e.g., 54 wt % in Example 1, and 42 wt % in Example 2) based on 100 wt % of the alkoxysilane component, better coordination could be achieved among the dialkoxy-substituted silane, the trialkoxy-substituted silane, and the tetraalkoxysilane owing to appropriate proportion of the trialkoxy-substituted silane (i.e., the total amount thereof being not greater than 60 wt %), allowing the protective film thus formed to have better ductility, and hence receive a grade of “excellent” in adhesion. Additionally, although the total amount of the trialkoxy-substituted silane in Example 5 was not greater than 60 wt % based on 100 wt % of the alkoxysilane component, due to a higher weight ratio (i.e., 1.7 in decimal form) of the acidic agent to the alkaline agent, the protective film thus formed merely received a grade of “good” in adhesion.

In each of Examples 1 to 6, when the weight ratio of the acidic agent to the alkaline agent ranged from 0.4 to 2.0 in decimal form (e.g., 0.78, 0.71, 0.69, 0.75, 1.7, and 0.43 in Examples 1 to 6, respectively), the protective film thus obtained received a grade of “excellent” or “good” in either adhesion or solvent resistance. Moreover, when the weight ratio of the acidic agent to the alkaline agent was further limited to range from 0.6 to 0.8 in decimal form (e.g., 0.78, 0.71, 0.69, and 0.75 in Examples 1 to 4, respectively), the protective film thus obtained received a grade of “excellent” in solvent resistance.

Referring to Tables 4, 5, and 9, in Comparative Example 2 or 3, when the weight ratio of the acidic agent to the alkaline agent was less than 0.4 (e.g., 0.1 and 0.39 in Comparative Examples 2 and 3, respectively), an insufficient amount of the acidic agent caused the coating kit of Comparative Example 2 or 3 failing to meet the requirements for forming a protective film. Consequently, the protective film thus formed had a less stable structure, resulting in a grade of “poor” in adhesion. In addition, in Comparative Example 4, when the weight ratio of the acidic agent to the alkaline agent increased to 3.2 in decimal form, the cross-linking degree among ingredients in the acidic agent and the alkaline agent became insufficient due to the alkaline agent being present in a less amount, resulting in the 3-aminopropyltrimethoxysilane being present in a less amount correspondingly. Therefore, the protective film thus obtained received a grade of “poor” in solvent resistance.

In addition, in Comparative Example 5, when the dialkoxy-substituted silane was present in the amount less than 10 wt % (i.e., 2.5 wt %) based on 100 wt % of the alkoxysilane component, the protective film thus obtained received a grade of “poor” in either adhesion or solvent resistance.

In summary, the effectiveness of the coating kit according to the present disclosure lies in an effectively shortened drying time required for forming the protective film due to the effects exerted by the acidic agent and the alkaline agent. In addition, the protective film formed from the coating kit of the present disclosure has a grade of “excellent” or “good” in either adhesion or solvent resistance. Specifically, at the drying temperature of approximately 50° C., the coating layer formed after the acidic agent and the alkaline agent are mixed and coated can be dried in approximately one morning or one afternoon (specifically, approximately 3 hours) to form the protective film, which allows the coating kit of the present disclosure to be successfully implemented to achieve an anti-corrosion effect. With such grade of “excellent” or “good” in either adhesion or solvent resistance, the protective film thus formed is capable of meeting commercial requirements.

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, FIGURE, or description thereof for the purpose of streamlining the disclosure and aiding in the understanding of various inventive aspects; such does not mean that every one of these features needs to be practiced with the presence of all the other features. In other words, in any described embodiment, when implementation of one or more features or specific details does not affect implementation of another one or more features or specific details, said one or more features may be singled out and practiced alone without said another one or more features or specific details. It should be further noted that one or more features or specific details from one embodiment may be practiced together with one or more features or specific details from another embodiment, where appropriate, in the practice of the disclosure.

While the disclosure has been described in connection with what is (are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. A coating kit, comprising:
an acidic agent which includes an alkoxysilane component present in an amount ranging from 25 wt % to 40 wt % based on 100 wt % of the acidic agent, and a first solvent, the alkoxysilane component including a dialkoxy-substituted silane present in an amount not less than 10 wt % based on 100 wt % of the alkoxysilane component, the first solvent including water and a first alcohol, and
an alkaline agent which includes, based on 100 wt % of the alkaline agent, water present in an amount not greater than 5 wt %, an aminoalkyl-substituted and alkoxy-substituted silane present in an amount ranging from 20 wt % to 50 wt %, and a second solvent, the second solvent including a second alcohol;
wherein the acidic agent and the alkaline agent are separately packaged, and a weight ratio of the acidic agent to the alkaline agent ranges from 0.4 to 2.0 in decimal form, and
wherein the alkoxysilane component is free from an aminoalkyl-substituted and alkoxy-substituted silane.

2. The coating kit as claimed in claim 1, wherein the alkoxysilane component further includes a trialkoxy-substituted silane and a tetraalkoxysilane, and the weight ratio of the acidic agent to the alkaline agent ranges from 0.6 to 2.0 in decimal form.

3. The coating kit as claimed in claim 2, wherein based on 100 wt % of the alkoxysilane component, the dialkoxy-substituted silane is present in an amount ranging from 10 wt % to 35 wt %, the trialkoxy-substituted silane is present in an amount ranging from 40 wt % to 80 wt %, and the tetraalkoxysilane is present in an amount ranging from 10 wt % to 30 wt %.

4. The coating kit as claimed in claim 3, wherein based on 100 wt % of the alkoxysilane component, the trialkoxy-substituted silane is present in an amount ranging from 40 wt % to 60 wt %.

5. The coating kit as claimed in claim 4, wherein the weight ratio of the acidic agent to the alkaline agent ranges from 0.6 to 0.8 in decimal form.

6. The coating kit as claimed in claim 2, wherein the dialkoxy-substituted silane is a dimethoxy-substituted silane.

7. The coating kit as claimed in claim 6, wherein the trialkoxy-substituted silane is a trimethoxy-substituted silane.

8. The coating kit as claimed in claim 7, wherein the tetraalkoxysilane is tetraethoxysilane.

9. The coating kit as claimed in claim 6, wherein the dimethoxy-substituted silane is dimethoxydimethylsilane.

10. The coating kit as claimed in claim 7, wherein the trimethoxy-substituted silane is selected from the group consisting of methyltrimethoxysilane, 3-glycidoxypropyltrimethoxysilane, and a combination thereof.

11. The coating kit as claimed in claim 1, wherein the aminoalkyl and alkoxy-substituted silane is 3-aminopropyltrimethoxysilane or N-2-(aminoethyl)-3-aminopropyltrimethoxysilane.

12. The coating kit as claimed in claim 1, wherein the acidic agent further includes an oxide present in an amount ranging from 5 wt % to 15 wt % based on 100 wt % of the acidic agent, the oxide being selected from the group consisting of silicon dioxide, titanium dioxide, zirconium dioxide, and combinations thereof.

13. The coating kit as claimed in claim 1, wherein the acidic agent is prepared by subjecting the alkoxysilane component and the first solvent to a heat treatment at a temperature ranging from 60° C. to 80° C. for a time period ranging from 4 hours to 9 hours.

14. The coating kit as claimed in claim 1, wherein the alkoxysilane component further includes a trialkoxy-substituted silane and is free from a tetraalkoxysilane, and the dialkoxy-substituted silane is present in an amount ranging from 10 wt % to 35 wt % based on 100 wt % of the alkoxysilane component.
